(19) United States
(12) Patent Application Publication
(10) Pub. No.: US 2008/0293880 A1
(43) Pub. Date: Nov. 27, 2008

(54) Liquid, Thermally Curable Mixtures, Their Preparation and Use

(75) Inventors: Andreas Poppe, Sendenhorst (DE); Elke Westhoff, Steinfurt (DE); Simone Hesener, Muenster (DE)

Correspondence Address: Mary E. Golota;Cantor Colburn LLP, 201 W. Big Beaver Road, Suite 1101, Troy, MI, 48084, US

(73) Assignee: BASF COATINGS AG, Munster (DE)

(21) Appl. No.: 12/096,484

(22) PCT Filed: Dec. 8, 2006
(86) PCT No.: PCT/EP06/11851

§ 371 Date: Jun. 6, 2008

(30) Foreign Application Priority Data
Dec. 9, 2005 (DE) 102005058891.3

(51) Int. Cl. C08G 18/32

(52) U.S. Cl. 524/590; 528/85

(57) ABSTRACT

Liquid, thermally curable mixtures comprising,
(A) low molecular weight polyols having at least three hydroxyl groups and a hydroxyl group content corresponding to a theoretical OH number of 800 to 1900 mg KOH/g,
(B) compounds selected from the group consisting of cyclic and acyclic C₉-C₁₆ alkanes functionalized with hydroxyl groups or hydroxyl and at least one thiol group, and
(C) low molecular weight or oligomeric compounds having reactive functional groups (c1) complementary to hydroxyl groups and thiol groups,
   processes for preparing them, and their use.

### FIELD OF THE INVENTION

The present invention relates to new, liquid, thermally curable mixtures. The present invention also relates to a new process for preparing liquid, thermally curable mixtures. The present invention relates not least to the use of the new, liquid, thermally curable mixtures and of the liquid, thermally curable mixtures prepared by the new process.

### PRIOR ART

Thermally curable mixtures, especially coating materials, in particular clearcoat materials, comprising compounds selected from the group consisting of cyclic and acyclic C₉-C₁₆ alkanes functionalized with at least two hydroxyl groups or with at least one hydroxyl and at least one thiol group are known from German patent applications DE 198 09 643 A1 and DE 199 40 855 A1. The known thermally curable coating materials necessarily include at least one polymeric binder. Thus, for example, DE 199 38 758 A1 describes, in example 1, the preparation of a polyester which is used as a polymer binder in clearcoat coating materials. In order to be able to handle, and in particular to apply, the known coating materials it is necessary to add comparatively large quantities of organic solvents to them. Although the compounds, as reactive diluents, do produce an improvement in this respect, since the viscosity of the known coating materials is significantly lower than that of coating materials free from these compounds, this effect is nevertheless inadequate to provide handleable—in particular, applicable—thermally curable mixtures, especially coating materials, in particular clear coat materials, which have an application solids of more than 80% by weight.

### PROBLEM ADDRESSED BY THE INVENTION

The object on which the present invention was based was to provide new, liquid, thermally curable mixtures which even with a film-forming solids of up to 100% by weight have a low viscosity, so allowing them to be readily processed and handled—in particular, applied.

The new, liquid, thermally curable mixtures ought to be outstandingly suitable for producing new thermoset materials.

In particular they ought to be outstandingly suitable as new coating materials, adhesives and sealants and also as new precursors for moldings and sheets for producing new thermoset coatings, adhesive layers and seals, and also moldings and sheets.

More particularly the new coating materials ought to be outstandingly suitable for use as primers, priming materials, surfacers, basecoat, solid-color topcoat and clearcoat materials for producing new single-coat or multicoat primer coats, anticorrosion coats, antistonechip priming coats, surfacer coats, basecoats, solid-color topcoats and clearcoats.

In particular, however, the new clearcoat materials ought to be outstandingly suitable for producing new, single-coat or multicoat clearcoat systems as part of new, multicoat color and/or effect paint systems, particularly of new multicoat paint systems produced by means of wet-on-wet techniques.

The new clear coats ought to exhibit very good flow, high gloss, low haze, high distinctiveness of image (DOI), and high chemical resistance, condensation resistance, weathering resistance, and scratch resistance. In addition they ought to be free from film defects such as bits, craters, pops, pinholes and pimples.

### SOLUTION PROVIDED BY THE INVENTION

Found accordingly have been the new, liquid, thermally curable mixtures comprising
(A) at least one low molecular weight polyol having at least three hydroxyl groups and a hydroxyl group content corresponding to a theoretical OH number of 800 to 1900 mg KOH/g,
(B) at least one compound selected from the group consisting of cyclic and acyclic C₉-C₁₆ alkanes functionalized with at least two hydroxyl groups or with at least one hydroxyl and at least one thiol group, and
(C) at least one low molecular weight or oligomeric compound having at least two reactive functional groups (c1) complementary to hydroxyl groups and thiol groups
   and referred to below as “mixtures of the invention”.

Also found has been the new process for preparing the mixtures of the invention, which involves
(1) mixing at least one polyol (A) with at least one compound (B) to give a molecularly dispersed solution or finely divided dispersion (1) and
(2) mixing the solution or dispersion (I) with at least one component (II) which comprises or consists of at least one compound (C), and homogenizing the resulting mixture
   and which is referred to below as “process of the invention”.

Found not least has been the new use of the mixtures of the invention, and of the mixtures of the invention prepared by the process of the invention, for producing new thermoset materials, this being referred to below as “inventive use”.

Further subject matters of the invention will become apparent from the description.

### ADVANTAGES OF THE INVENTION

In the light of the prior art it was surprising and unforeseeable for the skilled worker that the object on which the present invention was based could be achieved by means of the mixtures of the invention, the process of the invention, and the inventive use.

In particular it was surprising that even with a film-forming solids of up to 100% by weight the mixtures of the invention had a low viscosity and so could be readily processed and handled—in particular, applied.

The mixtures of the invention were outstandingly suitable for producing new thermoset materials.

In particular they were outstandingly suitable as new coating materials, adhesives and sealants and also as new precursors for moldings and sheets for producing new thermoset coatings, adhesive layers and seals, and also moldings and sheets.

More particularly the coating materials of the invention could be used outstandingly as new primers, priming materials, surfacers, basecoat, solid-color topcoat and clearcoat materials for producing new single-coat or multicoat primer coats, anticorrosion coats, antistonechip priming coats, surfacer coats, basecoats, solid-color topcoats and clearcoats.

In particular, however, the clearcoat materials of the invention were outstandingly suitable for producing new, single-coat or multicoat clearcoat systems as part of new, multicoat color and/or effect paint systems, particularly of new multicoat paint systems produced by means of wet-on-wet techniques.

The clear coats of the invention exhibited very good flow, high gloss, low haze, high distinctiveness of image (DOI), and high chemical resistance, condensation resistance, weathering resistance, and scratch resistance. Additionally they were free from film defects such as hazing, light/dark shading (clouds), bits, craters, pops, pinholes and pimples.

### DETAILED DESCRIPTION OF THE INVENTION

In the context of the present invention “low molecular weight” means that the compounds in question have a number-average molecular weight <1500 daltons.

“Oligomeric” means that the compounds in question are composed of 3 to 10 low molecular weight structural units. Preferably they have a number-average molecular weight of 500 to 10 000 daltons, more preferably of 1000 to 5000 daltons, and in particular 1500 to 4500 daltons.

“Polymeric” means that the compounds in question are composed of more than 10 low molecular weight structural units. Preferably they have a number-average molecular weight of 1000 to 100 000 daltons, more preferably 1500 to 50 000 daltons, and in particular of 2000 to 20 000 daltons.

The film-forming solids is the sum of all of the constituents of a thermally curable mixture which, when that mixture is cured, form the thermoset material.

The first inventively essential constituent of the mixture of the invention is at least one, especially one, low molecular weight polyol (A) having at least three, especially three, hydroxyl groups and having a hydroxyl group content corresponding to a theoretical OH number of 800 to 1900 mg KOH/g.

Suitable polyols (A) are all polyols having this profile of properties.

The polyol (A) is preferably selected from the group consisting of triols, tetrols, pentitols and hexitols.

The polyol (A) is selected more preferably from the group consisting of trimethylolmethane, trimethylolethane, trimethylolpropane, glycerol, erythritol, threitol, pentaerythritol, dipentaerythritol, homopentaerythritol, arabitol, adonitol, xylitol, mannitol, sorbitol, dulcitol and inositol.

Trimethylolpropane is used in particular.

The amount of the compound (A) in the mixture of the invention can vary widely and can therefore be adapted outstandingly to the requirements of the case in hand. The amount is preferably 1% to 30%, more preferably 2 to 25%, and in particular 3% to 20% by weight, based in each case on the film-forming solids of the mixture of the invention.

The second essential constituent of the mixture of the invention is at least one compound (B) from the group consisting of cyclic and acyclic C₉-C₁₆ alkanes functionalized with at least two hydroxyl groups or with at least one hydroxyl group and at least one thiol group, preferably with at least two hydroxyl groups, in particular with two hydroxyl groups.

Suitable C₉-C₁₆ alkanes from which the compounds (B) derive include basically all linear and branched, preferably branched, alkanes having 9 to 16 carbon atoms.

The C₉-C₁₆ alkanes from which the compounds (B) derive are selected preferably from the group consisting of 2-methyloctane, 4-methyloctane, 2,3-dimethylheptane, 3,4-dimethyl-heptane, 2,6-dimethylheptane, 3,5-dimethylheptane, 2-methyl-4-ethylhexane, isopropyl-cyclohexane, 4-ethyloctane, 2,3,4,5-tetramethylhexane, 2,3-diethylhexane 1-methyl-2-n-propylcyclohexane, 2,4,5,6-tetramethylheptane, 3-methyl-6-ethyloctane, 1′-ethyl-butylcyclohexane, positionally isomeric diethyloctanes, 3,4-dimethyl-5-ethylnonane, 4,6-dimethyl-5-ethylnonane, 3,4-dimethyl-7-ethyldecane, 3,6-diethylundecane, 3,6-dimethyl-9-ethylundecane, 3,7-diethyldodecane and 4-ethyl-6-isopropylundecane.

The C₉-C₁₆ alkanes preferably positionally isomeric diethyloctanes.

Preferred compounds (B), accordingly, are the positionally isomeric diethyloctanediols, more preferably those containing linear C₈ carbon chains.

The C₈ carbon chain here may have, in respect of the two ethyl groups, the substitution pattern 2,3, 2,4, 2,5, 2,6, 2,7, 3,4, 3,5, 3,6 or 4,5.

Similarly, the C₈ carbon chain, in respect of the two hydroxyl groups, can have the substitution pattern 1,2, 1,3, 1,4, 1,5, 1,6, 1,7, 1,8, 2,3, 2,4, 2,5, 2,6, 2,7, 2,8, 3,4, 3,5, 3,6, 3,7, 3,8, 4,5, 4,6, 4,8, 5,6, 5,7, 5,8, 6,7, 6,8 or 7,8.

The diethyloctanediols (B) are selected preferably from the group consisting of

2,3-diethyloctane-1,2-, 1,3-, 1,4-, 1,5-, 1,6-, 1,7-, 1,8-, 2,3-, 2,4-, 2,5-, 2,6-, 2,7-, 2,8-, 3,4-, 3,5-, 3,6-, 3,7-, 3,8-, 4,5-, 4,6-, 4,7-, 4,8-, 5,6-, 5,7-, 5,8-, 6,7-, 6,8- and -7,8-diol,
2,4-diethyloctane-1,2-, 1,3-, 1,4-, 1,5-, 1,6-, 1,7-, 1,8-, 2,3-, 2,4-, 2,5-, 2,6-, 2,7-, 2,8-, 3,4-, 3,5-, 3,6-, 3,7-, 3,8-, 4,5-, 4,6-, 4,7-, 4,8-, 5,6-, 5,7-, 5,8-, 6,7-, 6,8- and -7,8-diol,
2,5-diethyloctane-1,2-, 1,3-, 1,4-, 1,5-, 1,6-, 1,7-, 1,8-, 2,3-, 2,4-, 2,5-, 2,6-, 2,7-, 2,8-, 3,4-, 3,5-, 3,6-, 3,7-, 3,8-, 4,5-, 4,6-, 4,7-, 4,8-, 5,6-, 5,7-, 5,8-, 6,7-, 6,8- and -7,8-diol,
2,6-diethyloctane-1,2-, 1,3-, 1,4-, 1,5-, 1,6-, 1,7-, 1,8-, 2,3-, 2,4-, 2,5-, 2,6-, 2,7-, 2,8-, 3,4-, 3,5-, 3,6-, 3,7-, 3,8-, 4,5-, 4,6-, 4,7-, 4,8-, 5,6-, 5,7-, 5,8-, 6,7-, 6,8- and -7,8-diol,
2,7-diethyloctane-1,2-, 1,3-, 1,4-, 1,5-, 1,6-, 1,7-, 1,8-, 2,3-, 2,4-, 2,5-, 2,6-, 2,7-, 2,8-, 3,4-, 3,5-, 3,6-, 3,7-, 3,8-, 4,5-, 4,6-, 4,7-, 4,8-, 5,6-, 5,7-, 5,8-, 6,7-, 6,8- and -7,8-diol,
3,4-diethyloctane-1,2-, 1,3-, 1,4-, 1,5-, 1,6-, 1,7-, 1,8-, 2,3-, 2,4-, 2,5-, 2,6-, 2,7-, 2,8-, 3,4-, 3,5-, 3,6-, 3,7-, 3,8-, 4,5-, 4,6-, 4,7-, 4,8-, 5,6-, 5,7-, 5,8-, 6,7-, 6,8- and -7,8-diol,
3,5-diethyloctane-1,2-, 1,3-, 1,4-, 1,5-, 1,6-, 1,7-, 1,8-, 2,3-, 2,4-, 2,5-, 2,6-, 2,7-, 2,8-, 3,4-, 3,5-, 3,6-, 3,7-, 3,8-, 4,5-, 4,6-, 4,7-, 4,8-, 5,6-, 5,7-, 5,8-, 6,7-, 6,8- and -7,8-diol,
3,6-diethyloctane-1,2-, 1,3-, 1,4-, 1,5-, 1,6-, 1,7-, 1,8-, 2,3-, 2,4-, 2,5-, 2,6-, 2,7-, 2,8-, 3,4-, 3,5-, 3,6-, 3,7-, 3,8-, 4,5-, 4,6-, 4,7-, 4,8-, 5,6-, 5,7-, 5,8-, 6,7-, 6,8- and -7,8-diol and
4,5-diethyloctane-1,2-, 1,3-, 1,4-, 1,5-, 1,6-, 1,7-, 1,8-, 2,3-, 2,4-, 2,5-, 2,6-, 2,7-, 2,8-, 3,4-, 3,5-, 3,6-, 3,7-, 3,8-, 4,5-, 4,6-, 4,7-, 4,8-, 5,6-, 5,7-, 5,8-, 6,7-, 6,8- and -7,8-diol.

With preference the two ethyl groups are in positions 2 and 4.

With preference the two hydroxyl groups are in positions 1 and 5.

2,4-diethyloctane-1,5-diol in particular is used as compound (B).

The positionally isomeric diethyloctanediols (B) are compounds which are known per se and can be prepared by conventional synthesis methods of organic chemistry such as that of base-catalyzed aldol condensation, or are obtained as by-products in industrial chemical syntheses such as the preparation of 2-ethylhexanol

The amount of compounds (B) in the mixture of the invention may vary widely and can therefore be outstandingly adapted to the requirements of the case in hand. The amount is preferably 2% to 60%, more preferably 5% to 50%, and in particular 10% to 40% by weight, based in each case on the film-forming solids of the mixture of the invention.

The third essential constituent of the mixture of the invention is at least one compound (C). It is preferred to use at least two, in particular two, compounds (C).

The compound (C) is low molecular weight or oligomeric and contains at least two, in particular at least three, reactive functional groups (c1) complementary to hydroxyl groups and thiol groups, especially to hydroxyl groups.

The complementary reactive functional groups (c1) are selected preferably from the group consisting of carboxyl, anhydride, epoxy, blocked and non-blocked isocyanate, urethane, methylol, methylol ether, silane, carbonate, and beta-hydroxyalkylamide groups.

More preferably the groups (c1) are selected from the group consisting of blocked and non-blocked isocyanate groups, urethane groups, methylol groups and methylol ether groups.

With particular preference the compounds (C) are selected from the group consisting of blocked and non-blocked polyisocyanates and amino resins.

The especially preferred compounds (C) are conventional crosslinking agents (C) such as are known, for example, from German patent application DE 198 09 643 A1, page 5, line 17, to page 6, line 61, or German patent application DE 199 40 855 A1, column 24, line 33, to column 27, line 24.

The amount of the compounds (C) in the mixture of the invention may also vary very widely, and so can be adapted outstandingly to the requirements of the case in hand. The amount is preferably 10% to 90%, more preferably 15% to 85%, and in particular 20% to 80% by weight, based in each case on the film-forming solids of the mixture of the invention.

The equivalent ratio
of hydroxyl groups in the polyols (A) and the compounds (B) or
of hydroxyl groups in the polyols (A) and the hydroxyl groups and thiol groups in the compounds (B)
   to
the complementary reactive functional groups (c1) in the compounds (C)
   may vary very widely and so can be adapted outstandingly to the requirements of the case in hand. The equivalent ratio is preferably 1:3 to 3:1, more preferably 1:2.5 to 2.5:1, very preferably 1:2 to 2:1, with very particular preference 1:1.5 to 1.5:1 and in particular 1:1.2 to 1.2:1.

Where additives (D) are used which likewise contain hydroxyl groups and/or thiol groups, these groups are taken into account when setting the equivalent ratio, such that the said ratio preferably remains within the preferred ranges described above.

The mixture of the invention may further comprise at least one additive (D). Suitable additives (D) are all of these substances commonly used in the field of coating materials, adhesives and sealants and also of the precursors of mouldings and sheets, in particular in the field of coating materials.

The additive (D) is preferably selected from the group consisting of polymeric and oligomeric binders curable physically, thermally and/or with actinic radiation; organic and inorganic solvents; salts which can be decomposed thermally without residue or substantially without residue; neutralizing agents; thermally curable reactive diluents other than the compounds (A) and (B); reactive diluents curable with actinic radiation; opaque and transparent, color and/or effect pigments; molecularly dispersed soluble dyes; opaque and transparent fillers; nanoparticles; light stabilizers; antioxidants; devolatilizers; wetting agents; emulsifiers; defoamers; slip additives; thermal crosslinking catalysts; polymerization inhibitors; thermolabile free-radical initiators; photoinitiators; adhesion promoters; flow control agents; rheological assistants; flame retardants; corrosion inhibitors; free-flow aids; waxes; siccatives; biocides; and matting agents.

Examples of suitable additives (D) are known from German patent applications
DE 199 40 855 A1, column 8, line 36, to column 12, line 42, column 14, line 48, to column 21, line 20, to column 29, line 45,
DE 100 27 292 A1, page 3, paragraph [0021], to page 5, paragraph [0040], page 5, paragraph [0051], to page 11, paragraph [0092], to page 12, paragraph [0099],
DE 199 30 665 A1, page 9, lines 25 to 34, and page 11, line 32, to page 13, line 20,
   and also from German patent
DE 100 18 581 C1, page 4, paragraphs [0033] to [0038].

It is a very particular advantage of the mixtures of the invention that even without polymeric and oligomeric binders (D) curable physically, thermally and/or with actinic radiation they produce thermoset materials which have outstanding performance properties.

Where the mixtures of the invention are used for producing transparent, especially clear, thermoset materials of the invention they do not contain any opaque additives (D).

The amount of the additives (D) in the mixture of the invention may vary widely, and so can be adapted optimally to the particular end-use. Preferably, the additives (D) are used in the conventional, effective amounts. These are familiar to the skilled worker on the basis of his or her general art knowledge, and he or she may be guided by the information in the German patent applications cited above.

The film-forming solids present in the mixture of the invention may vary widely and may therefore be adapted outstandingly to the requirements of the particular end-use. It is a very particular advantage of the mixture of the invention that it can have a particularly high film-forming solids content. The film-forming solids is preferably 30% to 100%, more preferably 35% to 100%, and in particular 40% to 100% by weight, based in each case on the mixture of the invention.

The mixtures of the invention are cured thermally.

This may involve the conventional thermal crosslinking via complementary reactive functional groups and/or autoreactive functional groups, i.e., groups able to react “with themselves”. For further details of this refer to Römpp Lexikon Lacke und Druckfarben, Georg Thieme Verlag, Stuttgart, N.Y., 1998, “Curing” pages 274 to 276, especially page 275, bottom. Examples of suitable complementary reactive functional groups are known from patent application DE 100 42 152 A1, page 7, paragraph [0078], to page 9, paragraph [0081].

Thermal curing may be assisted by curing initiated with actinic radiation. In this case curing takes place via groups containing bonds which can be activated with actinic radiation. Actinic radiation for the purposes of the present invention is electromagnetic radiation, such as near infrared (NIR) visible light, UV radiation, x-rays or gamma radiation, especially UV radiation, and particulate radiation such as electron beams, alpha radiation, beta radiation or neutron beams, especially electron beams. Examples of suitable bonds which can be activated with actinic radiation are known from patent application DE 100 42 152 A1, page 3, paragraphs [0021] to [0027].

The thermal cure or dual cure may additionally be assisted by physical curing. In the context of the present invention the term “physical curing” denotes the curing of a layer of a mixture of the invention by film-forming, with linking within the layer taking place via a looping of the polymer molecules of the binders that are present. Or else filming takes place by the coalescence of binder particles (cf. Römpp Lexikon Lacke und Druckfarben, Georg Thieme Verlag, Stuttgart, N.Y., 1998, “Curing”, pages 274 and 275).

The mixtures of the invention may be free from organic solvents and water, i.e., they may be what are called 100% systems. They may be systems dissolved or dispersed, i.e., suspended or emulsified, in organic solvents and/or water. They may be one-component systems, in which the constituents (A) and (B) and the compounds (C) are present alongside one another, or may be two-component or multicomponent systems, in which the constituents (A) and (B) on the one hand and the compounds (C) on the other are present separately from one another until shortly before application.

In particular the mixtures of the invention are 100% systems or systems dissolved in organic solvents.

The mixtures of the invention are preferably prepared by the process of the invention, which involves
(1) mixing at least one polyol (A) with at least one compound (B) to give a molecularly dispersed solution or finely divided dispersion (1), and
(2) mixing the solution or dispersion (I) with at least one component (II) which comprises or consists of at least one compound (C), and homogenizing in the resulting mixture.

In the course of this process, in step (1) and/or in step (2) and/or after step (1) and/or after step (2), it is preferred to add at least one additive (D), preferably a wetting agent (D), in particular a nonionic surfactant (D) (cf. Römpp Online 2005, “Niotenside”), [nonionic surfactant]).

In particular the wetting agent (D) is added in step (1) of the process.

This process is carried out preferably using the conventional mixing techniques and apparatus such as ultrasound baths, stirred tanks, agitator mills, extruders, kneading apparatus, Ultraturrax, in-line dissolvers, static mixers, micromixers, toothed-wheel dispersers, pressure relief nozzles and/or microfluidizers, in the absence where appropriate of actinic radiation.

In the context of the inventive use, the mixtures of the invention serve for producing the thermoset materials of the invention.

In the context of the inventive use, the mixtures of the invention serve preferably as coating materials, adhesives and sealants of the invention and also as precursors of the invention for moldings and sheets, especially coating materials, the production of coatings, adhesive layers and seals of the invention, and also of moldings and sheets, especially coatings.

With particular preference the coating materials of the invention are used as electrocoat materials, primer coats, surfacers or antistonechip primers, basecoat materials, solid-color topcoat materials and clear coat materials for producing electrocoats, primer coats, surfacer coats or antistonechip primer coats, base coats, solid-color top coats and clear coats. These coating systems maybe single-coat or multicoat systems. With very particular preference they are multicoat systems and in that case may comprise at least two coats, in particular at least one electrocoat, at least one surface coat or antistonechip primer coat, and at least one base coat and at least one clear coat or at least one solid-color top coat. With particular preference the multicoat paint systems comprise at least one base coat and at least one clear coat.

It is of particular advantage to produce the clear coat of the multicoat paint systems of the invention from the mixtures of the invention. The clear coats are the outermost layers of the multicoat paint systems, substantially determining the overall visual appearance and protecting the color and/or effect base coats against mechanical, chemical and radiation-induced damage. The clear coats of the invention prove in this case to be
particularly insensitive to mechanical stress such as traction, elongation, impact, scratching or abrasion,
particularly resistant to moisture (in the form for example of water vapor), solvents and dilute chemicals, and
particularly resistant to environmental influences such as temperature fluctuations and UV radiation, and have
a high gloss and
effective adhesion to a wide variety of substrates.

Not least they display no yellowing after their production.

Depending on the intended use the mixtures of the invention are applied to conventional temporary or permanent substrates.

For producing sheets and moldings of the invention it is preferred to use conventional temporary substrates, such as metallic or polymeric belts or hollow bodies made of metal, glass, plastic, wood or ceramic, which are easily removable without damaging the sheets and moldings of the invention.

Where the mixtures of the invention are used for producing coatings, adhesive layers and seals, permanent substrates are employed.

The substrates in question are preferably
means of land, water or air transport that are operated by muscle power, hot air or wind, such as cycles, railroad trolleys, rowboats, sailboats, hot air balloons, gas balloons or sailplanes, and all said parts thereof,
motorized means of land, water or air transport, such as motorcycles, utility vehicles or motor vehicles, especially automobiles, water-going or underwater craft or aircraft, and all said parts thereof,
stationary floating structures, such as buoys or parts of harbor installations,
the interior and exterior of buildings,
doors, windows, and furniture, and
hollow glassware,
small industrial parts, such as nuts, bolts, hubcaps or wheel rims,
containers, such as coils, freight containers or packaging,
electrical components, such as electronic windings, coils for examples,
optical components,
mechanical components, and
white goods, such as household appliances, boilers and radiators.

The sheets and moldings of the invention may likewise serve as substrates.

In particular the substrates are automobile bodies and parts thereof. In this context the mixtures of the invention and the coatings of the invention produced from them serve preferably for the OEM finishing of automobile bodies or for the refinishing of inventive and noninventive OEM finishes. The OEM finishes of the invention, particularly those which include a clear coat of the invention, feature outstanding overpaintability. The refinishes of the invention adhere outstandingly to the inventive and noninventive OEM finishes.

In terms of method the application of the mixtures of the invention has no peculiarities, but may instead take place by any of the conventional application methods suitable for the mixture in question, such as electrocoating, injecting, spraying, knife coating, spreading, pouring, dipping, trickling or rolling, for example. Preference is given to employing spray application methods.

In the course of application it is advisable to operate in the absence of actinic radiation if the mixtures of the invention are additionally curable with actinic radiation.

For producing the multicoat paint systems of the invention it is possible in particular to employ wet-on-wet methods and coat systems of the kind known, for example, from German patent applications DE 199 30 067 A1, page 15, line 23, to page 16, line 36, or DE 199 40 855 A1, column 30, line 39, to column 31, line 48, and column 32, lines 15 to 29. It is a key advantage of the inventive use that in principle all coats of the multicoat paint systems of the invention can be produced from the mixtures of the invention.

The mixtures of the invention are generally cured after a certain rest time or flash-off time. This may have a duration of 30 s to 2 h, preferably 1 min to 1 h, and in particular 1 to 45 min. The rest time serves, for example, for the flow and devolatilization of the applied mixtures of the invention and for the evaporation of volatile constituents such any solvent present. Flashing-off may be accelerated by means of an elevated temperature, but not one sufficient for curing, and/or by means of a reduced atmospheric humidity.

The thermal curing of the applied mixtures of the invention takes place with the aid for example of a gaseous, liquid and/or solid, hot medium, such as hot air, heated oil or heated rollers, or of microwave radiation, infrared light and/or a near infrared (NIR) light. Heating takes place preferably in a forced-air oven or by exposure to IR and/or NIR lamps. As in the case of curing with actinic radiation, thermal curing as well may take place in stages. Thermal curing takes place advantageously at temperatures from room temperature to 200° C.

The thermal curing of the mixtures of the invention may also be carried out with substantial or complete exclusion of oxygen.

For the purposes of the present invention, oxygen is regarded as substantially excluded if its concentration at the surface of the applied mixtures of the invention is <21%, preferably <18%, more preferably <16%, very preferably 14%, with very particular preference 10%, and in particular <6%, by volume.

For the purposes of the present invention, oxygen is considered completely excluded if its concentration at the surface is below the detection limits of the conventional detection methods.

The oxygen concentration is preferably ≧0.001%, more preferably ≧0.01%, very preferably ≧0.1%, and in particular ≧0.5% by volume.

The desired concentrations of oxygen can be set by means of the measures described in German patent DE 101 30 972 C1, page 6, paragraphs [0047] to [0052] or by the laying on of films.

Curing with actinic radiation may be carried out by means of the conventional apparatus and methods of the kind described, for example, in German patent application DE 198 18 735 A1, column 10, lines 31 to 61, German patent application DE 102 02 565 A1, page 9, paragraph [0092], to page 10, paragraph [0106], German patent application DE 103 16 890 A1, page 17, paragraphs [0128] to [0130], international patent application WO 94/11123, page 2, line 35, to page 3, line 6, page 3, lines 10 to 15, and page 8, lines 1 to 14, or the American patent U.S. Pat. No. 6,743,466 B2, column 6, line 53, to column 7, line 14.

The thermoset materials of the invention, particularly the sheets, moldings, coatings, adhesive layers and seals of the invention, are outstandingly suitable for coating, bonding, sealing, wrapping and packing the substrates described above.

The resultant substrates of the invention coated with coatings of the invention, bonded with adhesive layers of the invention, sealed with seals of the invention and/or wrapped or packaged with sheets and/or moldings of the invention have outstanding service properties in conjunction with a particularly long service life.

### EXAMPLES

### Example 1

### The Preparation of Clearcoat Material 1

2 parts by weight of ethyl ethoxypropionate, 5 parts by weight of 2,4-diethyloctane-1,5-diol, 2.8 parts by weight of trimethylolpropane and 0.2 part by weight of Triton® X 100 (nonionic surfactant from Fluka) were mixed with one another and homogenized with ultrasound at 55° C. for 10 minutes. This gave a clear, storage-stable solution (A/B) which even after storage for 35 days at 40° C. showed no change in viscosity.

The compound (C1) (blocked polyisocyanate) was prepared by reacting 46.6 parts by weight of Basonat® HI 100 (polyisocyanate based on hexamethylene diisocyanate, from BASF AG), in solution in 30 parts by weight of ethyl ethoxypropionate, with 23.4 parts by weight of 3,5-dimethylpyrazole for four hours at 50° C. After this time free isocyanate groups were no longer detectable.

To prepare clearcoat material 1, 25 parts by weight of solution (A/B) and 16.6 parts by weight of TACT (Tris(alkoxycarbonylamino)triazine; cf. DE 199 40 855 A1, column 26, lines 27 to 53, in particular lines 49 to 53; compound C2) were mixed with one another.

The resulting mixture was heated at 70° C. for an hour to form a clear solution. Added to this solution were 57.5 parts by weight of the solution of the blocked polyisocyanate (C1), 0.2 part by weight of Byk® 302 (commercial additive from Byk Chemie) and 0.7 part by weight of dibutyltin dilaurate. Thereafter the resulting mixture was homogenized.

The resultant clear coat material 1 was completely clear. Even after a number of weeks of storage at 40° C. there was no observable hazing, streaking or phase separation. The material was outstandingly suitable for producing clearcoats as part of multicoat color and/or effect paint systems.

### Example 2

The Production of a Black Multicoat Paint System with a Clearcoat 1

Test panels used were steel panels which had been coated with a conventional, cathodically deposited and baked electrocoat. Atop the electrocoats was applied in each case one coat of a conventional water-based surfacer from BASF Coatings AG and one coat of a conventional black aqueous basecoat material (“nachtschwarz”) from BASF Coatings AG, application taking place wet on wet. Following their application the coats were each initially dried at 80° C. for 10 minutes.

The clearcoat material 1 from example 1 was applied to the test panels. The resultant wet clearcoat films 1 were baked together with the initially dried water-based surfacer film and the initially dried aqueous basecoat film at 150° C. for 23 minutes. The dry film thickness of the resulting clearcoats 1 was 40 μm.

The overall visual appearance of the resulting multicoat paint systems was outstanding. Their clearcoats 1 exhibited outstanding flow and were free from defects, such as bits, craters, light/dark shading (clouds), pimples, pinholes, orange peel and cracks. They were particularly clear and bright.

The clearcoats 1 exhibited very good chemical resistance. In the gradient oven test damage first became evident at above 43° C. for sulfuric acid, above 61° C. for NaOH, above 37° C. for pancreatin, above 58° C. for tree resin, and above 45° C. for distilled water.

The clearcoats were also scratch resistant and in the Amtec Kistler carwash simulation test (cf. T. Klimmasch and T. Engbert, Technologietage, Köln, DFO, conference report of volume 32, pages 59 to 66, 1997) they gave a residual gloss, after cleaning with wash benzine, of 58 units.

1. A liquid, thermally curable mixture, comprising:
(A) at least one low molecular weight polyol comprising at least three hydroxyl groups and a hydroxyl group content corresponding to a theoretical OH number of 800 to 1900 mg KOH/g;
(B) at least one compound selected from the group consisting of cyclic C₉-C₁₆ alkanes functionalized with at least two hydroxyl groups, acyclic C₉-C₁₆ alkanes functionalized with at least two hydroxyl groups, cyclic C₉-C₁₆ alkanes functionalized with at least one hydroxyl and at least one thiol group, and acyclic C₉-C₁₆ alkanes functionalized with at least one hydroxyl and at least one thiol group; and
(C) at least one low molecular weight or oligomeric compound having at least two reactive functional groups (c1) complementary to hydroxyl groups and thiol groups;
wherein the liquid, thermally curable mixture is a coating material, adhesive or sealant.

2. The liquid, thermally curable mixture of claim 1, comprising at least one additive (D).

3. The liquid, thermally curable mixture of claim 2, wherein the additive (D) is selected from the group consisting of polymeric and oligomeric binders curable physically, polymeric and oligomeric binders curable thermally, polymeric and oligomeric binders curable with actinic radiation; organic solvents, inorganic solvents; salts which can be decomposed thermally without residue or substantially without residue; neutralizing agents; thermally curable reactive diluents other than the compounds (A) and (B); reactive diluents curable with actinic radiation; opaque color pigments, opaque effect pigments, transparent color pigments, transparent effect pigments; molecularly dispersed soluble dyes; opaque fillers, transparent fillers; nanoparticles; light stabilizers; antioxidants; devolatilizers; wetting agents; emulsifiers; defoamers; slip additives; thermal crosslinking catalysts; polymerization inhibitors; thermolabile free-radical initiators; photoinitiators; adhesion promoters; flow control agents; rheological assistants; flame retardants; corrosion inhibitors; free-flow aids; waxes; siccatives; biocides; and matting agents.

4. The liquid, thermally curable mixture of claim 1, wherein the at least one low molecular weight polyol (A) is selected from the group consisting of trimethylolmethane, trimethylolethane, trimethylolpropane, glycerol, erythritol, threitol, pentaerythritol, dipentaerythritol, homopentaerythritol, arabitol, adonitol, xylitol, mannitol, sorbitol, dulcitol and inositol.

5. The liquid, thermally curable mixture of claim 4, wherein the at least one low molecular weight polyol (A) is trimethylolpropane.

6. The liquid, thermally curable mixture of claim 1, wherein the at least one compound (B) is a diol.

7. The liquid, thermally curable mixture of claim 1, wherein the C₉-C₁₆ alkanes are selected from the group consisting of 2-methyloctane, 4-methyloctane, 2,3-dimethylheptane, 3,4-dimethylheptane, 2,6-dimethylheptane, 3,5-dimethylheptane, 2-methyl-4-ethylhexane, isopropylcyclohexane, 4-ethyloctane, 2,3,4,5-tetramethylhexane, 2,3-diethylhexane 1-methyl-2-n-propylcyclohexane, 2,4,5,6-tetramethylheptane, 3-methyl-6-ethyloctane, 1′-ethylbutylcyclohexane, positionally isomeric diethyloctanes, 3,4-dimethyl-5-ethylnonane, 4,6-dimethyl-5-ethylnonane, 3,4-dimethyl-7-ethyldecane, 3,6-diethylundecane, 3,6-dimethyl-9-ethylundecane, 3,7-diethyldodecane and 4-ethyl-6-isopropylundecane.

8. The liquid, thermally curable mixture of claim 7, wherein the C₉-C₁₆ alkanes are positionally isomeric diethyloctanes.

9. The liquid, thermally curable mixture of claim 8, wherein the at least one compound (B) is a diethyloctanediol.

10. The liquid, thermally curable mixture of claim 9, wherein the diethyloctanediol comprises a linear C₈ carbon chain.

11. The liquid, thermally curable mixture of claim 10, wherein the linear C₈ carbon chain, with respect to the two ethyl groups, has a substitution pattern 2,3, 2,4, 2,5, 2,6, 2,7, 3,4, 3,5, 3,6 or 4,5.

12. The liquid, thermally curable mixture of claim 10, wherein the linear C₈ carbon chain, with respect to the two hydroxyl groups, has a substitution pattern 1,2, 1,3, 1,4, 1,5, 1,6, 1,7, 1,8, 2,3, 2,4, 2,5, 2,6, 2,7, 2,8, 3,4, 3,5, 3,6, 3,7, 3,8, 4,5, 4,6, 4,8, 5,6, 5,7, 5,8, 6,7, 6,8 or 7,8.

13. The liquid, thermally curable mixture of claim 10, wherein the diethyloctanediol is selected from the group consisting of 2,3-diethyloctane-1,2-diol, 2,3-diethyloctane-1,3-diol, 2,3-diethyloctane-1,4-diol, 2,3-diethyloctane-1,5-diol, 2,3-diethyloctane-1,6-diol, 2,3-diethyloctane-1,7-diol, 2,3-diethyloctane-1,8-diol, 2,3-diethyloctane-2,3-diol, 2,3-diethyloctane-2,4-diol, 2,3-diethyloctane-2,5-diol, 2,3-diethyloctane-2,6-diol, 2,3-diethyloctane-2,7-diol, 2,3-diethyloctane-2,8-diol, 2,3-diethyloctane-3,4-diol, 2,3-diethyloctane-3,5-diol, 2,3-diethyloctane-3,6-diol, 2,3-diethyloctane-3,7-diol, 2,3-diethyloctane-3,8-diol, 2,3-diethyloctane-4,5-diol, 2,3-diethyloctane-4,6-diol, 2,3-diethyloctane-4,7-diol, 2,3-diethyloctane-4,8-diol, 2,3-diethyloctane-5,6-diol, 2,3-diethyloctane-5,7-diol, 2,3-diethyloctane-5,8-diol, 2,3-diethyloctane-6,7-diol, 2,3-diethyloctane-6,8-diol, 2,3-diethyloctane-7,8-diol, 2,4-diethyloctane-1,2-diol, 2,4-diethyloctane-1,3-diol, 2,4-diethyloctane-1,4-diol, 2,4-diethyloctane-1,5-diol, 2,4-diethyloctane-1,6-diol, 2,4-diethyloctane-1,7-diol, 2,4-diethyloctane-1,8-diol, 2,4-diethyloctane-2,3-diol, 2,4-diethyloctane-2,4-diol, 2,4-diethyloctane-2,5-diol, 2,4-diethyloctane-2,6-diol, 2,4-diethyloctane-2,7-diol, 2,4-diethyloctane-2,8-diol, 2,4-diethyloctane-3,4-diol, 2,4-diethyloctane-3,5-diol, 2,4-diethyloctane-3,6-diol, 2,4-diethyloctane-3,7-diol, 2,4-diethyloctane-3,8-diol, 2,4-diethyloctane-4,5-diol, 2,4-diethyloctane-4,6-diol, 2,4-diethyloctane-4,7-diol, 2,4-diethyloctane-4,8-diol, 2,4-diethyloctane-5,6-diol, 2,4-diethyloctane-5,7-diol, 2,4-diethyloctane-5,8-diol, 2,4-diethyloctane-6,7-diol, 2,4-diethyloctane-6,8-diol, 2,4-diethyloctane-7,8-diol, 2,5-diethyloctane-1,2-diol, 2,5-diethyloctane-1,3-diol, 2,5-diethyloctane-1,4-diol, 2,5-diethyloctane-1,5-diol, 2,5-diethyloctane-1,6-diol, 2,5-diethyloctane-1,7-diol, 2,5-diethyloctane-1,8-diol, 2,5-diethyloctane-2,3-diol, 2,5-diethyloctane-2,4-diol, 2,5-diethyloctane-2,5-diol, 2,5-diethyloctane-2,6-diol, 2,5-diethyloctane-2,7-diol, 2,5-diethyloctane-2,8-diol, 2,5-diethyloctane-3,4-diol, 2,5-diethyloctane-3,5-diol, 2,5-diethyloctane-3,6-diol, 2,5-diethyloctane-3,7-diol, 2,5-diethyloctane-3,8-diol, 2,5-diethyloctane-4,5-diol, 2,5-diethyloctane-4,6-diol, 2,5-diethyloctane-4,7-diol, 2,5-diethyloctane-4,8-diol, 2,5-diethyloctane-5,6-diol, 2,5-diethyloctane-5,7-diol, 2,5-diethyloctane-5,8-diol, 2,5-diethyloctane-6,7-diol, 2,5-diethyloctane-6,8-diol, 2,5-diethyloctane-7,8-diol, 2,6-diethyloctane-1,2-diol, 2,6-diethyloctane-1,3-diol, 2,6-diethyloctane-1,4-diol, 2,6-diethyloctane-1,5-diol, 2,6-diethyloctane-1,6-diol, 2,6-diethyloctane-1,7-diol, 2,6-diethyloctane-1,8-diol, 2,6-diethyloctane-2,3-diol, 2,6-diethyloctane-2,4-diol, 2,6-diethyloctane-2,5-diol, 2,6-diethyloctane-2,6-diol, 2,6-diethyloctane-2,7-diol, 2,6-diethyloctane-2,8-diol, 2,6-diethyloctane-3,4-diol, 2,6-diethyloctane-3,5-diol, 2,6-diethyloctane-3,6-diol, 2,6-diethyloctane-3,7-diol, 2,6-diethyloctane-3,8-diol, 2,6-diethyloctane-4,5-diol, 2,6-diethyloctane-4,6-diol, 2,6-diethyloctane-4,7-diol, 2,6-diethyloctane-4,8-diol, 2,6-diethyloctane-5,6-diol, 2,6-diethyloctane-5,7-diol, 2,6-diethyloctane-5,8-diol, 2,6-diethyloctane-6,7-diol, 2,6-diethyloctane-6,8-diol, 2,6-diethyloctane-7,8-diol, 2,7-diethyloctane-1,2-diol, 2,7-diethyloctane-1,3-diol, 2,7-diethyloctane-1,4-diol, 2,7-diethyloctane-1,5-diol, 2,7-diethyloctane-1,6-diol, 2,7-diethyloctane-1,7-diol, 2,7-diethyloctane-1,8-diol, 2,7-diethyloctane-2,3-diol, 2,7-diethyloctane-2,4-diol, 2,7-diethyloctane-2,5-diol, 2,7-diethyloctane-2,6-diol, 2,7-diethyloctane-2,7-diol, 2,7-diethyloctane-2,8-diol, 2,7-diethyloctane-3,4-diol, 2,7-diethyloctane-3,5-diol, 2,7-diethyloctane-3,6-diol, 2,7-diethyloctane-3,7-diol, 2,7-diethyloctane-3,8-diol, 2,7-diethyloctane-4,5-diol, 2,7-diethyloctane-4,6-diol, 2,7-diethyloctane-4,7-diol, 2,7-diethyloctane-4,8-diol, 2,7-diethyloctane-5,6-diol, 2,7-diethyloctane-5,7-diol, 2,7-diethyloctane-5,8-diol, 2,7-diethyloctane-6,7-diol, 2,7-diethyloctane-6,8-diol, 2,7-diethyloctane-7,8-diol, 3,4-diethyloctane-1,2-diol, 3,4-diethyloctane-1,3-diol, 3,4-diethyloctane-1,4-diol, 3,4-diethyloctane-1,5-diol, 3,4-diethyloctane-1,6-diol, 3,4-diethyloctane-1,7-diol, 3,4-diethyloctane-1,8-diol, 3,4-diethyloctane-2,3-diol, 3,4-diethyloctane-2,4-diol, 3,4-diethyloctane-2,5-diol, 3,4-diethyloctane-2,6-diol, 3,4-diethyloctane-2,7-diol, 3,4-diethyloctane-2,8-diol, 3,4-diethyloctane-3,4-diol, 3,4-diethyloctane-3,5-diol, 3,4-diethyloctane-3,6-diol, 3,4-diethyloctane-3,7-diol, 3,4-diethyloctane-3,8-diol, 3,4-diethyloctane-4,5-diol, 3,4-diethyloctane-4,6-diol, 3,4-diethyloctane-4,7-diol, 3,4-diethyloctane-4,8-diol, 3,4-diethyloctane-5,6-diol, 3,4-diethyloctane-5,7-diol, 3,4-diethyloctane-5,8-diol, 3,4-diethyloctane-6,7-diol, 3,4-diethyloctane-6,8-diol, 3,4-diethyloctane-7,8-diol, 3,5-diethyloctane-1,2-diol, 3,5-diethyloctane-1,3-diol, 3,5-diethyloctane-1,4-diol, 3,5-diethyloctane-1,5-diol, 3,5-diethyloctane-1,6-diol, 3,5-diethyloctane-1,7-diol, 3,5-diethyloctane-1,8-diol, 3,5-diethyloctane-2,3-diol, 3,5-diethyloctane-2,4-diol, 3,5-diethyloctane-2,5-diol, 3,5-diethyloctane-2,6-diol, 3,5-diethyloctane-2,7-diol, 3,5-diethyloctane-2,8-diol, 3,5-diethyloctane-3,4-diol, 3,5-diethyloctane-3,5-diol, 3,5-diethyloctane-3,6-diol, 3,5-diethyloctane-3,7-diol, 3,5-diethyloctane-3,8-diol, 3,5-diethyloctane-4,5-diol, 3,5-diethyloctane-4,6-diol, 3,5-diethyloctane-4,7-diol, 3,5-diethyloctane-4,8-diol, 3,5-diethyloctane-5,6-diol, 3,5-diethyloctane-5,7-diol, 3,5-diethyloctane-5,8-diol, 3,5-diethyloctane-6,7-diol, 3,5-diethyloctane-6,8-diol, 3,5-diethyloctane-7,8-diol, 3,6-diethyloctane-1,2-diol, 3,6-diethyloctane-1,3-diol, 3,6-diethyloctane-1,4-diol, 3,6-diethyloctane-1,5-diol, 3,6-diethyloctane-1,6-diol, 3,6-diethyloctane-1,7-diol, 3,6-diethyloctane-1,8-diol, 3,6-diethyloctane-2,3-diol, 3,6-diethyloctane-2,4-diol, 3,6-diethyloctane-2,5-diol, 3,6-diethyloctane-2,6-diol, 3,6-diethyloctane-2,7-diol, 3,6-diethyloctane-2,8-diol, 3,6-diethyloctane-3,4-diol, 3,6-diethyloctane-3,5-diol, 3,6-diethyloctane-3,6-diol, 3,6-diethyloctane-3,7-diol, 3,6-diethyloctane-3,8-diol, 3,6-diethyloctane-4,5-diol, 3,6-diethyloctane-4,6-diol, 3,6-diethyloctane-4,7-diol, 3,6-diethyloctane-4,8-diol, 3,6-diethyloctane-5,6-diol, 3,6-diethyloctane-5,7-diol, 3,6-diethyloctane-5,8-diol, 3,6-diethyloctane-6,7-diol, 3,6-diethyloctane-6,8-diol, 3,6-diethyloctane-7,8-diol, 4,5-diethyloctane-1,2-diol, 4,5-diethyloctane-1,3-diol, 4,5-diethyloctane-1,4-diol, 4,5-diethyloctane-1,5-diol, 4,5-diethyloctane-1,6-diol, 4,5-diethyloctane-1,7-diol, 4,5-diethyloctane-1,8-diol, 4,5-diethyloctane-2,3-diol, 4,5-diethyloctane-2,4-diol, 4,5-diethyloctane-2,5-diol, 4,5-diethyloctane-2,6-diol, 4,5-diethyloctane-2,7-diol, 4,5-diethyloctane-2,8-diol, 4,5-diethyloctane-3,4-diol, 4,5-diethyloctane-3,5-diol, 4,5-diethyloctane-3,6-diol, 4,5-diethyloctane-3,7-diol, 4,5-diethyloctane-3,8-diol, 4,5-diethyloctane-4,5-diol, 4,5-diethyloctane-4,6-diol, 4,5-diethyloctane-4,7-diol, 4,5-diethyloctane-4,8-diol, 4,5-diethyloctane-5,6-diol, 4,5-diethyloctane-5,7-diol, 4,5-diethyloctane-5,8-diol, 4,5-diethyloctane-6,7-diol, 4,5-diethyloctane-6,8-diol and 4,5-diethyloctane-7,8-diol.

14. The liquid, thermally curable mixture of claim 11, wherein the C₈ carbon chain, with respect to the two ethyl groups, has a substitution pattern 2,4.

15. The liquid, thermally curable mixture of claim 12, wherein the C₈ carbon chain, with respect to the two hydroxyl groups, has a substitution pattern 1,5.

16. The liquid, thermally curable mixture of claim 10, wherein the diethyloctanediol is 2,4-diethyloctane-1,5-diol.

17. The liquid, thermally curable mixture of claim 1, wherein the at least two reactive functional groups (c1) complementary to hydroxyl groups and thiol groups are selected from the group consisting of carboxyl groups, anhydride groups, epoxy groups, blocked isocyanate groups, non-blocked isocyanate groups, urethane groups, methylol groups, methylol ether groups, silane groups, carbonate groups, and beta-hydroxyalkylamide groups.

18. The liquid, thermally curable mixture of claim 17, wherein the at least two reactive functional groups (c1) complementary to hydroxyl groups and thiol groups are selected from the group consisting of blocked isocyanate groups, non-blocked isocyanate groups, urethane groups, methylol groups and methylol ether groups.

19. The liquid, thermally curable mixture of claim 18, wherein the at least one low molecular weight or oligomeric compound (C) is selected from the group consisting of blocked polyisocyanates, non-blocked polyisocyanates and amino resins.

20. The liquid, thermally curable mixture of claim 1, comprising the at least one low molecular weight polyol (A) in an amount of 1% to 30% by weight, based on film-forming solids of the thermally curable mixture.

21. The liquid, thermally curable mixture of claim 1, comprising the at least one compound (B) in an amount of 2% to 60% by weight, based on film-forming solids of the thermally curable mixture.

22. The liquid, thermally curable mixture of claim 1, comprising the at least one low molecular weight or oligomeric compound (C) in an amount of 10% to 90% by weight, based on film-forming solids of the thermally curable mixture.

23. The liquid, thermally curable mixture of claim 1, wherein the equivalent ratio of hydroxyl groups in the at least one low molecular weight polyol (A) and the at least one compound (B) or of hydroxyl groups in the at least one low molecular weight polyol (A) and the hydroxyl groups and thiol groups in the at least one compound (B) to the at least two reactive functional groups (c1) in the at least one low molecular weight or oligomeric compound (C) is 1:3 to 3:1.

24. The liquid, thermally curable mixture of claim 1, having a film-forming solids content of 30% to 100% by weight.

25. A process for preparing the liquid, thermally curable mixture of claim 1, comprising:
(1) mixing at least one low molecular weight polyol (A) with at least one compound (B) to give a molecularly disperse solution or finely divided dispersion (I);
(2) mixing the molecularly disperse solution or finely divided dispersion (I) with at least one component (II) which comprises or consists of at least one low molecular weight or oligomeric compound (C); and
(3) homogenizing the resulting mixture.

26. The process of claim 25, wherein in step (1) and/or in step (2) and/or after step (1) and/or after step (2) at least one additive (D) is added.

27. The process of claim 26, wherein a wetting agent (D) is added in step (1).

28. Thermoset materials comprising the thermally curable mixture of claim 1.

29. The thermoset materials of claim 28, wherein the thermoset materials are coatings, adhesive layers, seals, moldings or sheets.

30. The thermoset materials of claim 29, wherein the coating materials are primers, priming coatings, surfacers, basecoat materials, solid-color topcoat materials or clearcoat materials for producing single-coat or multicoat primer coating systems, anticorrosion coats, antistonechip primer coats, surfacer coats, basecoats, solid-color top coats or clearcoats.

31. The thermoset materials of claim 30, wherein the clear coat materials are single-coat or multicoat clearcoat systems as part of multicoat color and/or effect paint systems.

32. The thermoset materials of claim 31, wherein the multicoat color and/or effect paint systems are produced by means of wet-on-wet methods.

33. The thermoset materials of claim 28, wherein the coating materials are for refinishing OEM finishes.

34. The thermoset materials of claim 33, wherein the OEM finishes are on automobile bodies.
